(19) United States
(12) Patent Application Publication
(10) Pub. No.: US 2004/0013815 A1
(43) Pub. Date: Jan. 22, 2004

(54) Method for coating sheet metals

(76) Inventor: Georg Gros, Oppenau (DE)

Correspondence Address: FULBRIGHT & JAWORSKI, LLP, 666 FIFTH AVE, NEW YORK, NY, 10103-3198, US

(21) Appl. No.: 10/221,716

(22) PCT Filed: May 7, 2001
(86) PCT No.: PCT/EP01/05084

(30) Foreign Application Priority Data
May 8, 2000 (DE) 100 22 352.4

(51) Int. Cl. B05D 3/06

(52) U.S. Cl. 427/558

(57) ABSTRACT

The invention relates to method for coating sheet metals such as coils with a chromate-free, water-dilutable, organic UV-curing anti-corrosive coating, and for curing said coating by irradiation with UV light. The inventive method is further characterized in that a dispersion or emulsion is used as the UV-curing coating agent for forming the anti-corrosive coating that substantially consist of 25 to 80 wt.-% binder, 1 to 8 wt.-% photoinitiations, 0 to 5 wt.-% additives, 20 to 70 wt.-% water, and optionally a pigment. The coating agent is applied on the sheet metal, preferably in an inline method, dried to form a film and cured by UV light.

The present invention relates to a novel process for coating metal sheets, in particular electrolytically galvanized or hot-dip galvanized metal sheets, such as, for example, coils (strip), with a chromate-free, organic, UV-hardening corrosion-protection coating and of curing it by irradiation with UV light.

Because of the high requirement imposed on the corrosion protection, metallically pre-finished, in particular hot-dip galvanising prefinished, fine sheets are being used in the building, domestic appliance and vehicle industry to an increasing extent. In addition to the established hot-dip galvanized sheets, coatings with zinc/aluminium alloys and electrolytically galvanized sheets have also been used more recently. A relatively loose, voluminous layer of zinc hydroxide (white rust) which, in the case of fairly large proportions of aluminium, has a grey to black colouration (black rust) and which has only a slight protective action is formed on unprotected zinc or zinc/aluminium coatings in the presence of water and atmospheric oxygen.

To passivate the zinc surface against the attack of water and atmospheric oxygen, it has therefore long proved satisfactory to apply a thin chromate layer by applying and drying a thin layer of chromium trioxide in water, optionally in the presence of complexes of zirconic or hexafluorosilicic acids, as a result of which there is formed on the surface a thin layer of zinc chromate into which zirconium ions and fluoride ions are additionally intercalated and which protects the underlying layer of pure zinc.

A further improvement in the corrosion protection can be achieved by also applying, in addition, a protective film based, for example, on polyacrylates to this chromium passivating layer. The direct application of a polyacrylate film instead of chromate has also been described, but the passivating action is not as good as combined use (cf. B. Schuhmacher et al., Bänder Bleche Rohre, vol. 9 (1997), pages 24 to 28).

Disadvantageous with these methods is, on the one hand, the toxicity of chromium compounds and their use and processing should therefore be avoided for environmental reasons and, on the other hand, the requirement when applying polymeric protective films, in particular acrylic lacquers, that, even in the thin layers of a few μm which are used, drying or stoving at temperatures of up to 150° C. require that, immediately downstream of the coater used for applying the seal, the oven must have an appreciable length at present production speeds of such coils, in order to make possible a sufficiently uniform drying and stoving of the lacquer. Solvent vapours produced form an additional disadvantage of this method. A processing of sheets that automatically crosslink thermally and harden at temperatures of approximately 120° C. (bake hardening) after said method is impossible since the lacquer stoving temperatures are higher than the crosslinking temperature and would consequently cure such sheets prematurely.

DE 197 51 153 A1 discloses a chromate-free coil coating of steel sheets in which titanium, manganese and/or zirconium salts are applied with olefinically unsaturated polymerizable carboxylic acids and optionally further olefinic comonomers in a 0.5 to 10 μm thick layer and there is curing by UV light in 3 minutes. Decisive for the corrosion protection is a high proportion of metal salts since salt-free coatings corrode. The long curing time makes such coatings unsuitable for a continuous use in coil production. A content of solvent and/or readily volatilising comonomers presents a further production risk because of the fire danger.

DE 25 21 986 discloses UV-radiation-hardening coating compositions of adducts of acrylic acid and an epoxy resin that still contain reactive acrylate monomer and can be applied to metal, paper, leather etc. as paint layers of 1 to 20 mg per 6.4 cm², i.e approximately 1.5 to 30 μm layer thickness. The curing takes place by UV irradiation for 1 to 30 seconds and 6 minutes post-curing at 165° C. Such coatings are unsuitable for coil coatings since they cannot be deformed because of their thickness and the high stoving temperatures result in a premature hardening of the metal sheets.

From EP 0 257 812 A2 it is known, furthermore, to produce by UV hardening a protective coating for metals, synthetic plastics or wood, composed of a mixture of a nitrile/acrylate copolymer with a multifunctional monomer in a reactive thinner composed of an olefinically unsaturated polymerizable monomer, such as acrylic ester. The system is consequently free of solvents which do not react. The layer thickness is 2.5 to 76 μm and the curing takes place with UV light at room temperature until the coating is no longer tacky. This requires appreciable time and, in addition, these mixtures are flammable because of the proportion of monomer.

The object was therefore to find a process for coating metal sheets, in particular galvanized metal sheets, with which a thin corrosion-protection film can be applied and hardened rapidly and without using high temperatures and which preferably also makes possible a sufficient corrosion resistance without pre-treatment with chromium.

The achieving of this object is made possible by the features of the main claim and is furthered by the subclaims.

In the context of this application, the term “metal sheet” comprises single-rolled sheet, coil (“strip”), strip segments and stampings. The metal sheet is preferably readily workable.

In principle, very many different metallic surfaces of metal sheets can be used as substrate for coating. These include, in particular, aluminium, aluminium-containing alloys, magnesium alloys, steels, stainless steels, titanium, titanium alloys, pure zinc, zinc-containing alloys and galvanized surfaces, in particular hot-dip galvanized or electrolytically galvanized surfaces.

The coating agents used according to the invention that are hardenable by UV light are known. In addition to solvent-based lacquer formulations, aqueous systems or powder stoving coatings, which are mainly processed in industrial lacquering, such radiation-hardening resins, with a market share hitherto of only 4%, tend, however, to be exotic products. Radiation-hardenable aqueous lacquer formulations are primarily used in the wood paint sector, followed by overprinting inks and finally printing inks. Another application is the radiation hardening of a solid layer through a mask so that the unexposed areas can be washed out and, for example, a printed relief can form from the hardened locations. Other applications are synthetic plastic lacquers for PVC floors, skis, and the use of viscous polymer/reactive thinner mixtures in light-hardenable dental materials.

The fact that thin coatings that firmly adhere to metal surfaces and do not chip off even when thermally and flexurally stressed can be formed with aqueous suspensions of UV-hardenable materials was not previously known.

Compared with the lacquer coatings hitherto known, the aqueous, UV-hardenable materials according to the invention have the great advantage that they cure even at comparatively low temperatures, preferably at temperatures in the range from 20 to 40° C., do not have to liberate any organic solvents and form dense, solid coatings that constitute a good corrosion protection.

Surprisingly, the water added as a viscosity-regulating agent can be rapidly expelled, in particular in a time interval of 6 to 2 seconds from the thin layers, preferably layers in the range of 1 to 2 μm dry-film thickness, required for the corrosion protection of coils at temperatures in the range from 50 to 100° C., so that a continuous processing is possible.

A further advantage of such UV-hardening coating systems is that they only or almost only cure under UV light and can therefore be stored well and impurities from the machines and residues of the coating agent that have not been exposed to the UV light can readily be wiped or washed off with water in the application system, whereas, in the case of standard solvent-containing lacquers, dried-on residues form firmly adhering films that can only be removed again with difficulty. A further advantage of the coating agents according to the invention is that they have a comparatively low sliding friction coefficient, preferably in the range from 0.10 to 0.14 that makes possible a good workability of the metal sheets, for example, in the case of rolled sections, during deep drawing or bending, such limiting drawing behaviour being determined, for example, by the standard cupping test and being defined as the ratio of the diameter of the largest circular blank to be die-drawn without wrinkles to the male die diameter. For galvanized metal sheets, for example, a sliding friction coefficient of 0.1 is achieved with a sealing according to the invention having a thickness of approximately 1 μm. Coatings according to the invention can normally be readily adhesively bonded or joined to additional colour lacquers, with the result that they simultaneously may act as primers.

Radiation-hardenable coating agents are composed of a water-thinnable, radiation-hardenable base resin, optionally an elasticizing resin, and also one or more photoinitiators. Additionally, additives, such as agents that improve the contact with metal or control the polymerization, for example phosphoric acid acrylates, acrylic-functional polydimethylsiloxanes, aluminium phosphate or amine compounds can also advantageously be added.

In order to be processable, solvent-free radiation-hardenable coating agents according to the prior art require appreciable amounts of the “reactive thinners” that simultaneously act as solvent and polymerizable component. At the same time it is known that said reactive thinners increase in viscosity with increasing molecular weight and, on the other hand, although they are of low viscosity at low molecular weight, in particular in the range from 100 to 250 g/mol (20 sec/ISO 2431/5), and consequently have solvent properties, they also have a correspondingly higher vapour pressure so that they are emitted into the environment during processing or, if they are not completely incorporated in the lacquer matrix, they can still be emitted afterwards from the curing lacquer.

According to the invention, aqueous radiation-hardenable lacquers are therefore used that can be processed as aqueous dispersions or emulsions so that the additions of low-molecular-weight reactive thinners can be dispensed with. Such products can contain as binders base resins, as aqueous polyacrylate dispersions or emulsions, unsaturated acrylic ester resins and/or urethane acrylic resins and also emulsifiers, surfactants and/or preservatives and water. During drying out, these products form films that are post-hardened by the radiation. Elasticizing resins and photoinitiators and also other additives correspond to the products known with water-free mixtures, it additionally being possible also to add emulsifiers for the resins, protective colloids etc. in small amounts as additives.

The composition of the UV lacquers according to the invention may vary within relatively wide limits, standard formulations containing, for example, binder: 25 to 80 wt. %, preferably 30 to 50 wt. %, photoinitiators: 1 to 8 wt. %, preferably 2 to 6 wt. %, additives: 0 to 5 wt. %, preferably 1 to 3 wt. % and water: 70 to 20 wt. %, preferably 60 to 40 wt. %.

Further dilution of the systems with water is, however, possible in order to achieve particularly thin dry-film layers. The mixtures then contain, in particular: binder: 5 to 40 wt. %, preferably 10 to 30 wt. %, photoinitiators: 0.1 to 6 wt. %, preferably 0.5 to 5 wt. %, additives: 0 to 4 wt. %, preferably 0.3 to 2.5 wt. % and water: 90 to 60 wt. %, preferably 80 to 65 wt. %.

In particular, pigments may, in addition, be present with a content in the range from 0.1 to 60 wt. %, in particular more than 5 or even more than 8 wt. %, preferably less than 32 or even less than 25 wt. %. In this connection, the pigment content is calculated in addition to the sum of all the other constituents of a mixture, including the solvent=100 wt. %, so that a mixture containing, for example, 12 wt. % of pigment(s) is in total 112 wt. %.

Since the acrylate-based radiation-hardenable films are possibly too brittle as a result of the hardness desired. per se in certain mixtures and may therefore be inclined to chip off from the base, it is advantageous to add an elasticizing binder in these cases, for which purpose the addition of unsaturated aliphatic urethane acrylic prepolymers or polyurethane dispersions has proved beneficial. These substances are added optionally in amounts of up to 15 wt. %, preferably of 1 to 10 wt. %.

Antioxidants, biocides, dispersants, defoaming agents, fillers, adhesion promoters, such as, for example, silanes, wetting agents, pigments, waxes and/or stabilizers may be added as additives or may already be present in the product to be mixed. Dimethylsiloxanes may, in this connection, serve as lubricant and wetting additive, polyethylene waxes as forming aid, and aluminium phosphate, alkaline earth oxides and morpholine derivatives as corrosion protection additive.

Inter alia, inorganic and/or organic corrosion inhibiters, electrically conductive polymers, electrically conductive particles, such as, for example, oxides, phosphates, phosphides, in particular of aluminium and/or iron or graphite/soot, inorganic pigments, such as, for example, carbonates, oxides, phosphates, phosphides, silicates, graphite/mica, in particular in the form of layer particles or nanoparticles, can advantageously be added as pigments.

Preferred mixtures of base resins, elasticizing resins, photoinitiators and additives may be, for example:

polyester acrylate/urethane acrylate/phenyl ketone/dimethylsiloxane or

polyester and styrene acrylate/urethane acrylate/phenyl ketone/dimethylsiloxane or

polyester and pure acrylate/urethane acrylate/phenyl ketone/dimethylsiloxane or

polyester, styrene and pure acrylate/urethane acrylate/phenyl ketone/dimethylsiloxane or

polyester acrylate/urethane acrylate/phenyl ketone/dimethylsiloxane and phosphoric acid ester.

The mixtures are available as dispersions, in particular as emulsions, which also are denoted here as coating agent. The coating agent preferably serves as primer, in particular as lubricant primer.

Before the application of the coating agent to the metallic surface of the substrate, a homogeneous mixture has to be prepared from the constituents of the coating agent, which is optionally also diluted with a fairly large amount of fully demineralized water and homogenized. The homogenization may take place by stirring. The processing viscosity may also advantageously be simultaneously adjusted by the addition of these amounts. During the processing, it may be necessary to add up to 10 vol. % of fully demineralized water and to homogenize.

The viscosity of the coating agent in the case of application by rolling is preferably in the range from 20 to 40 sec/ISO 2431/5 and in the case of application by spraying preferably in the range from 12 to 20 sec/ISO 2431/5.

The proportion of solids in the coating agent in the case of application by rolling is preferably in the range from 20 to 35% and in the case of application by spraying is preferably in the range from 15 to 25%, no account being taken of the pigment content. The individual added pigments may each have a mean particle size in the range from 0.001 to 10 μm preferably in the range from 0.01 to 4 μm.

The density of the coating agent in the case of application by rolling is preferably in the range from 1.1 to 1.2 g/cm³ and in the case of application by spraying is preferably in the range from 1.05 to 1.1 g/cm³, no account still being taken of the pigment content.

The pH value of the coating agent in the case of application by rolling or/and by spraying is preferably in the range from 1 to 3.

The mixtures are advantageously selected in such a way that an adequate or complete crosslinking or curing can be achieved solely by actinic radiation without an additional thermal crosslinking or curing being necessary.

The coating agent may be applied by the basically known processes to the metallic surface(s) of the substrate. The coating agent can be applied to individual metal sheets or to a metal sheet in the form of a strip (coil). Particularly advantageous is rolling-on, for example, with a roller coater, spraying on and squeegeeing with a roller or immersion and squeegeeing with a roller, in particular, in the in-line method. By the in-line method is meant a coating agent application, in particular a primer application, in a galvanizing line. Alternatively, a coating in a coil-coating line (off line) is, inter alia, possible. Prior to applying or on applying to the coating agent, the latter does not have to be heated. When applying the coating agent to the metallic surface, the coating agent is preferably at a temperature in the range from 18 to 40° C., in particular of 20 to 25° C. Conversely, it is advantageous if the substrate with the metallic surface to be coated is at a temperature in the range from 18 to 60° C., in particular of 25 to 40° C., during application of the coating agent.

The coating agent may be applied with a wet-film thickness in the range from 0.2 to 100 μm, in particular in the range from 0.5 to 75 μm, particularly preferably in the range from 1 to 40 μm, quite particularly preferably in the range from 2 to 20 μm. After drying and after actinic irradiation, the dry-film thickness of the corrosion protection coating produced is preferably 0.1 to 20 μm, particularly preferably 0.3 to 12 μm, quite particularly preferably 0.5 to 8 μm, especially 0.8 to 6 μm. The layer thickness may be determined, for example, gravimetrically.

The coating agent is applied to the metallic surface preferably onto a surface freshly coated with a metallic layer, such as, for example, a galvanization layer or onto a cleaned and pickled and, optionally, additionally activated metallic surface. In addition, at least one pretreatment layer, such as, for example, a phosphate layer may be applied to which the coating agent according to the invention can then be applied.

It goes without saying that the water-containing resin film must first be dried after application to at least one of the surfaces of the metal sheet before a crosslinking and curing by UV irradiation can take place. The disadvantages of the additional drying step are, however, compensated for again by the omission of the monomeric constituents and by the greater hardness and strength of the dried films produced. In other respects, the water contained can be dried off at substrate temperatures in the range from 50 to 100° C. so that the conversion temperature of, for example, 120° C. is not reached even in the case of self-hardening metal sheets. Various drying times result depending on the quality of the coating plant and the chosen temperatures. For substrate temperatures in the range from 60 to 80° C., for example, 2 to 10 seconds, in particular 4 to 8 seconds, may be used for adequate drying. An inadequate predrying impairs the complete subsequent UV curing. After adequate drying, the crosslinking and curing can take place by irradiation with actinic radiation.

For radiation hardening, such mixtures can be crosslinked directly in known manner with electron beams that bring about the formation of free radicals, but electron-beam appliances are normally too expensive. Illumination with UV radiation that is generated by inexpensive mercury vapour lamps is therefore preferred for hardening, in which case addition of photoinitiators to the mixture is, however, necessary. Photoinitiators that form active free radicals in a wavelength range from 200 to 400 nm, which free radicals initiate polymerization, are known in the prior art. Used, inter alia, are benzoin ethers, such as benzoin isopropyl ether or benzil dimethyl ketal, 1-hydroxycyclohexyl phenyl ketone, 2-hydroxy-2-methyl-1-phenyl-1-propanone, benzophenones or also 2,4,6-trimethylbenzoyldiphenylphosphine oxide. Common to these compounds is that they readily form benzoyl radicals or benzyl radicals that add to double bonds and start the free-radical polymerization of the main components.

As UV source, use is nowadays normally made of high-pressure mercury vapour lamps that have, for example, a power per centimetre of 70 to 240 W or, in future, even more, in particular 80 to 160 W and preferably deliver a strong radiation in the range from 180 to 500 nm, particularly preferably in the range of 200 to 400 nm, in particular in the range of 220 to 350 nm, i.e. the main absorption of photoinitiators. Depending on the reactivity of the photoinitiators and the composition of the mixture to be hardened, most of the curing takes place within a few seconds, partly already below one second. In this connection, the mobility of the molecules in the reactive material also plays a part, with the result that temperatures of 50 to 100° C. can normally be employed, this resulting in reactions at up to over 96% of the double bonds present. The irradiation may take place in air or in an inert gas atmosphere, in particular in nitrogen.

For the UV curing, for example, a strip speed of 30 m per minute, a substrate-radiation source spacing of 8 cm, a mercury-doped lamp having a power of 160 W per cm of lamp length and a substrate temperature of 60° C. can be employed.

If four such lamps are used, the strip speed can be increased to approximately 120 m per minute.

The coating agent or the hardening or hardened corrosion-protection layer can be stripped with an organic solvent or with a solvent mixture, advantageously at the latest immediately after the UV irradiation. Water without an organic solvent added can be used only before the UV irradiation.

The coated material according to the invention can now be processed very well depending on application purpose, such as, for example, worked, deep-drawn, cut, punched, bonded and/or coated, in particular lacquered.

Compared with alternative methods of the prior art, the coating method according to the invention offers, the following advantages: the coating plant is only slightly soiled and can easily be cleaned since the coating agent does not normally dry on at room temperature and cures only with actinic radiation. In the case of continuous manufacture, high strip speeds can be set, in particular strip speeds in the range from 10 to 200 m per minute. The maximum substrate temperature is, for example, only 80° C. during crosslinking and curing, this also saving energy and costs. Particularly low sliding friction coefficients can be set. The coated substrate according to the invention is readily workable and the corrosion-protection coating also exhibits a high elasticity. The corrosion-protection coating can therefore pre-eminently be used as lubricant primer.

The advantage of the lubricant primer according to the invention is, inter alia, that an additional working agent, such as a forming oil or a drawing oil is no longer needed, even if it could in principle be used. If, nevertheless, an oil is to be used as forming agent, it should be removed after working and prior to further coating.

### EXAMPLES

In the following tables, formulations, processing conditions and results are reproduced by way of example for radiation-hardenable systems according to the invention without the invention thereby being restricted in any way.

Well mixed mixtures according to Table 1 were prepared and were applied to metal sheets having a thickness in a range from 0.6 to 5 mm, preferably in the range from 0.8 to 1.5 mm. The special processing conditions and the results of the subsequent laboratory investigations are entered in Table 2.

TABLE 1
Compositions of the mixtures of the examples
according to the invention

| Example | 1 | 2 | 3 | 4 | 5 |
|---|---|---|---|---|---|
| Quantity specifications in | wt. % | wt. % | wt. % | wt. % | wt. % |
| Base resin | | | | | |
| 1. Water-emulsified polyester | 12.50 | 12.50 | 12.50 | 12.50 | 25.00 |
| acrylate | | | | | |
| 2. Styrene acrylate dispersion | 14.50 | 14.50 | 14.50 | 14.50 | — |
| Elasticization | | | | | |
| 3. Aliphatic urethane acrylate | 0.75 | 1.00 | 1.00 | — | 2.50 |
| Photoinitiator | | | | | |
| 4. 1-hydroxycyclohexyl phenyl | 2.50 | 2.50 | 2.50 | 2.50 | 3.00 |
| ketone | | | | | |
| Additives | | | | | |
| 5. Polyether-modified olidimethyl- | 2.00 | 2.00 | 2.00 | 2.00 | 1.00 |
| siloxane | | | | | |
| 6. Polyethylene wax | 0.75 | 0.75 | 0.75 | 0.75 | — |
| 7. Aluminium triphosphate | — | 2.00 | — | — | — |
| 8. Calcium oxide (fine particles) | — | — | — | — | 2.00 |
| 9. Acid adduct of 4-oxo- | — | — | 2.00 | — | — |
| 4-p-tolylbutyl and 4-ethylmorpholine | | | | | |
| Solvent | | | | | |
| 10. Water | 66.00 | 64.75 | 64.75 | 67.75 | 66.50 |
| 11. Propylene glycol monopropyl | 1.00 | | | | |
| ether | | | | | |

TABLE 2
Properties of the mixtures according to the invention

| Example | 1 | 2 | 3 | 4 | 5 |
|---|---|---|---|---|---|
| Processing properties: | | | | | |
| Temperature in ° C. | 60 | 60 | 60 | 60 | 60 |
| Duration in sec. | 6 | 8 | 8 | 8 | 10 |
| Viscosity in sec/ISO 2431/5 mm | 28 | 30 | 30 | 27 | 28 |
| Layer thickness of the freshly applied | 6 | 6 | 6 | 6 | 6 |
| coating in μm | | | | | |
| UV curing conditions: | | | | | |
| Substrate temperature in ° C. | 80 | 80 | 80 | 80 | 80 |
| Strip speed in metres | 25 | 25 | 25 | 25 | 25 |
| UV lamp: CK (mercury-doped) | 160 | 160 | 160 | 160 | 160 |
| in W/cm | | | | | |
| Layer thickness of the cured coating | 1.5 | 1.5 | 1.5 | 1.5 | 1.5 |
| in μm | | | | | |
| Properties of the corrosion | | | | | |
| protection coating: | | | | | |
| Corrosion resistance according to | slight | none | slight | slight | none |
| DIN 50 021-SS after 240 h | | | | | |
| (white rust) | | | | | |
| Cross-cut testing according to | CC 0 | CC 0 | CC 0 | CC 0 | CC 0 |
| DIN 53 151 | | | | | |

1. Process for coating metal sheets, such as, for example, coils, with a chromate-free, water-thinnable, organic UV-hardening corrosion-protection coating and for curing the coating by irradiation with UV light, characterized in that use is made of a dispersion or emulsion that essentially consists of
25 to 80 wt. % binders,
1 to 8 wt. % photoinitiators,
0 to 5 wt. % additives,
20 to 70 wt. % water
and, optionally, at least one pigment as UV-hardening coating agent for forming the corrosion-protection coating, and in that the coating agent is applied in a thin layer to the metal sheet, dried to a film and hardened by means of UV light, preferably in the in-line method.

2. Method according to claim 1, characterized in that the binder contains polyacrylate, unsaturated acrylate ester resins and/or urethane acrylic resins as basic resin.

3. Method according to one of the preceding claims, characterized in that, as photoinitiator, use is made of a benzoin ether, such as benzoin isopropyl ether or benzil dimethyl ketal, or 1-hydroxycyclohexyl phenyl ketone, 2-hydroxy-2-methyl-l-phenyl-l-propanone, benzophenones or also 2,4,6-trimethylbenzoyldiphenylphosphine oxide.

4. Method according to one of the preceding claims, characterized in that an elasticizing resin formed from an unsaturated aliphatic urethane acrylate prepolymer is added to the mixture as an additive.

5. Method according to one of the preceding claims, characterized in that an emulsifier for the binder is added as an additive.

6. Method according to any of the preceding claims, characterized in that at least one pigment, in particular with a content in the range from 0.1 to 60 wt. %, is added to the mixture.

7. Method according to any of the preceding claims, characterized in that the corrosion-protection coating preferably has a dry-film thickness in the range from 0.1 to 20 μm, particularly preferably from 0.3 to 12 μm, quite particularly preferably from 0.5 to 8 μm, above all from 0.8 to 6 μm.

8. Method according to any of the preceding claims, characterized in that the metal sheet coated with the coating agent is dried at temperatures in the range from 50 to 100° C.

9. Method according to any of the preceding claims, characterized in that the UV light is generated with mercury vapour lamps radiating in the range from 180 to 500 nm, in particular in the range from 220 to 350 nm.

10. Method according to any of the preceding claims, characterized in that the metal sheet with the cured corrosion-protection coating is worked, cut and/or punched and also, optionally, additionally lacquered.

11. Method according to any of the preceding claims, characterized in that the worked, cut and/or punched metal sheet is joined to another structural element by clinching, bonding, welding and/or at least one further joining method.

12. Use of metal sheets having UV-hardening corrosion coatings produced according to one of the preceding claims, in vehicle technology, the aero or space industry, in particular for a body or a part of a body or as part of a vehicle, trailer, caravan or aircraft body, as covering, housing, lamp, light fitting, hanging light component, piece of furniture or furniture component, a domestic appliance component, shelving components, facade components, frame, section, moulding having a complicated geometry, crash barrier component, radiator component or fence component, bumper, window frame, door frame or bicycle frame.
